(19) United States
(12) Patent Application Publication
(10) Pub. No.: US 2017/0212711 A1
(43) Pub. Date: Jul. 27, 2017

(54) DISK APPARATUS AND CONTROL METHOD

(71) Applicant: Kabushiki Kaisha Toshiba, Tokyo (JP)

(72) Inventor: Hiroaki Inoue, Yokohama Kanagawa (JP)

(21) Appl. No.: 15/065,682

(22) Filed: Mar. 9, 2016

Related U.S. Application Data
(60) Provisional application No. 62/281,554, filed on Jan. 21, 2016.

(51) Int. Cl. G06F 3/06

(52) U.S. Cl. CPC G06F 3/0656; G06F 3/061; G06F 3/0676

(57) ABSTRACT

According to one embodiment, there is provided a disk apparatus including a disk medium, a buffer memory, and a controller. The controller includes an interface circuit used to connect to the buffer memory, in an execution of a command from a host to instruct a first access operation to the disk medium by using the buffer memory. The controller is configured to perform, if a second access operation to the disk medium by using the buffer memory is performed in background, a first wait process by a time according to the second access operation. The first wait process delays a response process of the command. The response process includes the first access operation.

### CROSS-REFERENCE TO RELATED APPLICATIONS

This application is based upon and claims the benefit of priority from U.S. Provisional Application No. 62/281,554, filed on Jan. 21, 2016; the entire contents of which are incorporated herein by reference.

### FIELD

Embodiments described herein relate generally to a disk apparatus and a control method.

### BACKGROUND

When a disk apparatus receives a command from a host, the disk apparatus performs an access operation to a disk medium while using a buffer memory, in accordance with the command, and transmits a predetermined notification to the host as a response to the command. At this time, it is desired to shorten the time for response to the host.

### BRIEF DESCRIPTION OF THE DRAWINGS

FIG. 1 is a view showing a configuration of a disk apparatus according to an embodiment;

FIG. 2 is a view showing a data structure of a wait process time table according to the embodiment;

FIG. 3 is a flow chart showing an operation of the disk apparatus according to the embodiment;

FIG. 4 is a sequence chart showing an operation of the disk apparatus according to the embodiment (when receiving a write command);

FIG. 5 is a view showing a data structure of a coefficient table according to a modification of the embodiment;

FIG. 6 is a view showing a data structure of a coefficient table according to another modification of the embodiment;

FIG. 7 is a flow chart showing an operation of the disk apparatus according to another modification of the embodiment; and

FIG. 8 is a sequence chart showing an operation of the disk apparatus according to another modification of the embodiment (when receiving a read command).

### DETAILED DESCRIPTION

In general, according to one embodiment, there is provided a disk apparatus including a disk medium, a buffer memory, and a controller. The controller includes an interface circuit used to connect to the buffer memory, in an execution of a command from a host to instruct a first access operation to the disk medium by using the buffer memory. The controller is configured to perform, if a second access operation to the disk medium by using the buffer memory is performed in background, a first wait process by a time according to the second access operation. The first wait process delays a response process of the command. The response process includes the first access operation.

Exemplary embodiments of a disk apparatus will be explained below in detail with reference to the accompanying drawings. The present invention is not limited to the following embodiments.

### Embodiment

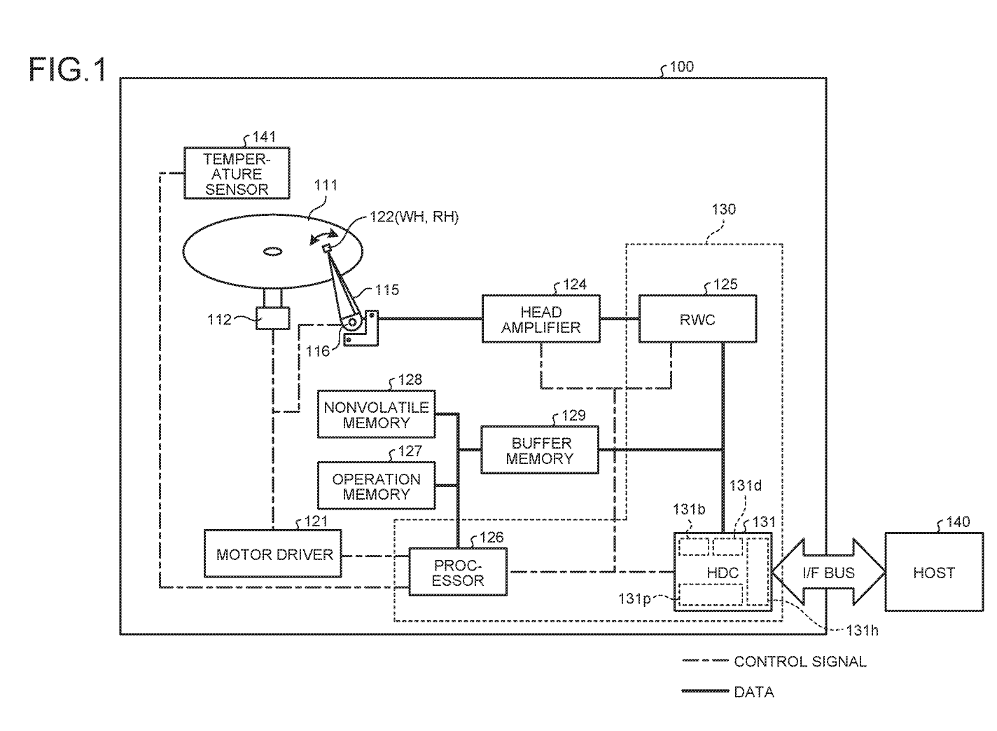

A disk apparatus 100 according to an embodiment will be described with reference to FIG. 1. FIG. 1 is a view showing a configuration of the disk apparatus 100.

For example, the disk apparatus 100 (such as a hard disk apparatus; HDD) is configured to write information into a disk medium 111 via a head 122 and to read a signal from the disk medium 111 via the head 122, and to serve as an external storage medium for a host 140. For example, the host 140 may be a processor or a peripheral circuit included in an information processing system. The information processing system includes the disk apparatus 100, a display device (not shown), and the host 140. The display device includes a screen, which may be a CRT display or may be a liquid crystal display, for example. The host 140 (processor) is configured to totally control the respective portions of the information processing system, for example, to read information stored in the disk apparatus 100, and to display an image corresponding to the read information on the screen of the display device. For example, the information processing system may be a personal computer; a mobile phone or imaging device; a mobile terminal device, such as a tablet computer or smart phone; a game device; or an on-vehicle terminal device, such as a car navigation system.

Specifically, the disk apparatus 100 includes the disk medium 111, a spindle motor (SPM) 112, a temperature sensor 141, a motor driver 121, the head 122, an actuator arm 115, a voice coil motor (VCM) 116, a head amplifier 124, a read/write channel (RWC) 125, a hard disk controller (HDC) 131, an operation memory 127, a nonvolatile memory 128, a buffer memory 129, and a processor 126.

The disk medium 111 can be rotated at a predetermined rotation number about a rotation axis by the SPM 112. The SPM 112 is driven to rotate by the motor driver 121. The temperature sensor 141 is disposed near the disk medium 111 (for example, on a printed board), and is configured to detect an ambient temperature around the disk medium 111.

The head 122 faces the disk medium 111, and is configured to write and read data with respect to the disk medium 111 by using a write head WH and read head RH equipped therein. The head 122 is attached to a distal end of the actuator arm 115, and can be moved in the radial direction (cross-track direction) of the disk medium 111 by the VCM 116 driven by the motor driver 121.

The head amplifier 124 is configured to amplify a signal read by the head 122 (read head RH) from the disk medium 111, and to output and supply the amplified signal to the RWC 125. Further, the head amplifier 124 is configured to supply the head 122 (write head WH) with a write current based on a signal, for writing data into the disk medium 111, sent from the RWC 125. The head amplifier 124 may be an integrated circuit of one chip. A package of the head amplifier 124 may be attached to a lateral surface of the actuator arm 115, for example.

The HDC 131 is configured to control transmission and reception of data between the host 140 via an I/F bus, and to control the buffer memory 129. The HDC 131 includes a host interface circuit 131h, a buffer interface circuit 131b, a disk interface circuit 131d, and a processor interface circuit 131p. The disk interface circuit 131d is configured to control transfer of user data (read data and write data) with respect to the disk medium 111 via the RWC 125 and the head amplifier 124. The processor interface circuit 131p is configured to exchange various kinds of commands and/or control information with the processor 126. The buffer interface circuit 131b is connected to the host interface circuit 131h and the disk interface circuit 131d, and is configured to execute read/write access control and/or read/write cache control to the buffer memory 129. The host interface circuit 131h is configured to receive commands and data from the host 140 and to transmit responses and data to the host 140.

It should be noted that, as the communication interface standard between the disk apparatus 100 (host interface circuit 131h) and the host 140, any arbitrary interface standard may be adopted. For example, SATA (Serial ATA) standard, SAS (Serial Attached SCSI) standard, PCI Express standard, or SCSI (Small Computer System Interface) standard may be adopted.

The buffer memory 129 is used as a cache for data transmitted and received with respect to the host 140. Further, the buffer memory 129 is used to temporarily store data read from the disk medium 111, data to be written into the disk medium 111, and/or control firmware read from the disk medium 111. The buffer memory 129 is formed of a DRAM, SDRAM, SRAM, MRAM, or FeRAM, for example.

The RWC 125 is configured to perform code modulation to data supplied from the HDC 131 to be written into the disk medium 111, and to supply it to the head amplifier 124. Further, the RWC 125 is configured to perform code demodulation to a signal read from the disk medium 111 and supplied via the head amplifier 124, and to output it as digital data to the HDC 131.

The processor 126 is connected to the operation memory 127 (such as an SRAM or DRAM), the nonvolatile memory 128 (such as a Flash ROM (Flash Read Only Memory) of the NOR type or NAND type), and the buffer memory 129 for temporary storage. The processor 126 is configured to perform the overall control of the disk apparatus 100, in accordance with firmware stored in the nonvolatile memory 128 or disk medium 111. The processor 126 is formed of a CPU or MPU, for example. The firmware includes initial firmware to be executed at first when the disk apparatus 100 is activated, and control firmware to be used when the disk apparatus 100 is in the normal operation. For example, the initial firmware may be stored in the nonvolatile memory 128, and the control firmware may be recorded in the disk medium 111. Under the control in accordance with the initial firmware, the control firmware may be read from the disk medium 111 once into the buffer memory 129 and then stored in the operation memory 127.

It should be noted that the hardware configuration including the RWC 125, the processor 126, and the HDC 131 can be regarded as a controller 130. The controller 130 may be formed of an integrated circuit of one chip (system-on chip). The controller 130 may be disposed on a printed board outside the casing (not shown).

In the disk apparatus 100, the controller 130 (host interface circuit 131h) receives commands and data from the host 140, and transmits responses and data to the host 140. Further, the controller 130 performs access operations (such as a write operation and a read operation) to the disk medium 111 in accordance with commands (such as a write command and a read command).

For example, when the host interface circuit 131h receives a write command and write data from the host 140, the controller 130 (processor 126) temporarily stores the write data into the buffer memory 129. Then, in accordance with the write command, the controller 130 (processor 126) performs a write operation of reading the write data from the buffer memory 129 and writing it into the disk medium 111 via the RWC 125 and the head amplifier 124, and the controller 130 transmits an execution completion notification about the write command to the host 140 as a response relating to the write operation.

Alternatively, for example, when the host interface circuit 131h receives a read command from the host 140, the controller 130 (processor 126) performs a read operation of reading read data from the disk medium 111 via the RWC 125 and the head amplifier 124 in accordance with the read command, and temporarily stores the read data into the buffer memory 129. Then, the controller 130 (processor 126) reads the read data from the buffer memory 129, and transmits it to the host 140. Thereafter, the controller 130 (processor 126) transmits an execution completion notification about the read command to the host 140 as a response relating to the read operation.

In the disk apparatus 100, in terms of the data access, the access speed to the disk medium 111 is lower than the access speed to the buffer memory 129.

Accordingly, when a command is executed, the buffer memory 129 is used as a cache buffer so that the response (reply) to the host 140 can be temporarily improved. However, the capacity of the buffer memory 129 is far smaller than the capacity of the disk medium 111. For example, the capacity of the buffer memory 129 (several MB) is a size corresponding to one several-millionth of the capacity of the disk medium 111 (several TB). Accordingly, when a background service accompanied by an access operation to the disk medium 111 is running, the buffer memory 129 is used for the access operation, and so the buffer memory 129 tends to be soon full. The background service is a process internally performed by the controller 130 in the disk apparatus 100 without depending on a command from the host 140, and this process is accompanied by an access operation to the disk medium 111. Since the background service is autonomously performed by the controller 130, its execution situation is difficult to grasp from the host 140 side.

If the background service causes data transmission from the buffer memory 129 into the disk medium 111 to be stagnated and causes the buffer memory 129 to be full, access to the disk medium 111 (data write or read) according to a command from the host 140 is stopped, and the buffer memory 129 becomes unable to be utilized as a cache.

On the other hand, there may be considered such control (first control) as to observe the vacant capacity of the buffer memory 129 at a predetermined sampling cycle, and to execute the access according to a command from the host 140, after waiting until the vacant capacity of the buffer memory 129 becomes equal to or higher than a threshold value for its usable state. The threshold value is determined in advance in consideration of a data amount serving as a unit of data transfer inside the disk apparatus 100 and a difference in access speed between the buffer memory 129 and the disk medium 111, and the threshold value is about 30% of the entire capacity (several MB) of the buffer memory 129, for example. The predetermined sampling cycle may be set long to some extent to have a certain length in consideration of hardware restrictions (such as the processing speed of the processor 126 and the transmission delay on the wiring line connecting the processor 126 to the buffer memory 129). In the first control, if the timing when the vacant capacity of the buffer memory 129 reaches the threshold value for its usable state is present in the middle of a sampling cycle (during observation), the access according to a command from the host 140 needs to be unnecessarily kept on standby until the next sampling timing. In this case, the response to the host 140 is delayed significantly, and so the response time with respect to a command from the host 140 may end up being prolonged. In the host 140, if the response time for a response command from the disk apparatus 100 with respect to a command from the host 140 is prolonged, under the circumstances that the host 140 is included in an information processing system serving as a game device for example, the image processing operation in the information processing system (using a command response as a trigger) is temporarily stopped (for example, for several seconds), and the display device screen falls in a frozen state. Consequently, the information processing system including the host 140 probably gives stress to the user.

Therefore, according to this embodiment, when a background service is executed in the disk apparatus 100, a wait process of intentionally delaying a process of responding to the command by a time according to the background service is performed to prevent the time for response to the host 140 from being prolonged.

Specifically, when the controller 130 executes a command that instructs an access operation (first access operation) to the disk medium 111, if a background service is in a state prepared its execution or during its execution, the controller 130 performs a wait process of delaying a process of responding to the command, which includes the access operation, by a time according to the execution situation of the background service. In the background service, a second access operation different from the first access operation is performed. The first access operation is an access operation (such as a write operation or read operation) performed based on a command from the host 140, but the second access operation is an access operation (a write operation or read operation) autonomously performed by the controller 130 without depending on the command.

By studying the time necessary for performing the wait process, it has been found that vacancies can be gradually generated in the buffer memory 129 after the lapse of a certain time from the start of a background service. For example, the controller 130 experimentally obtains in advance a period of time (which will be referred to as vacancy securing time, hereinafter) from when the buffer memory 129 becomes full until the vacant capacity of the buffer memory 129 becomes equal to or higher than a threshold value for its usable state (for example, 30% of the entire capacity). Further, it has been found that the vacancy securing time varies depending on the type of a background service.

The types of background services may include read retry, write retry, ATI refresh, data sector reassignment, and log recording, for example.

The read retry is performed when a read error is generated, such that it includes reading data from the disk medium 111 again by use of a change in read conditions (such as the read voltage and the position of the read head RH in the track width direction), and temporarily storing the data thus read or data restored by error correction into the buffer memory 129.

The write retry is performed when a write error is generated, such that it includes keeping data, which is to be written, stored in the buffer memory 129, and writing the data into the disk medium 111 again.

The ATI refresh includes being based on the number of times of write counted by the controller 130 for each zone of the disk medium 111, which is defined by a predetermined area in the radial direction, and rewriting data into a plurality of tracks belonging to a zone where the count value exceeds a predetermined threshold value. Further, the ATI refresh includes reading data from each track of a target zone of the disk medium 111 and temporarily storing the read data into the buffer memory 129, and then reading the stored data from the buffer memory 129 as write data and rewriting it into the original track of the disk medium 111.

The data sector reassignment is performed when a read error or write error is generated in the disk medium 111, such that it includes changing a physical address correlated to the logical address of erroneous data to another physical address, and then reading effective data from the buffer memory 129 and writing it into a sector corresponding to the physical address of the changed destination.

The log recording includes creating the history of read/write access to the disk medium 111 as log information and recording it into a management information storage area of the disk medium 111. The log recording may be recording of ordinary logs (such as the number of times of execution of a read/write operation in each time zone, and statistical information about error contents). Alternatively, the log recording may be recording of logs, in compliance with SMART (Self-Monitoring Analysis and Reporting Technology) standard, (such as the cumulative number of times of a read/write error, the ambient temperature around the disk medium 111, and the cumulative operation time of the disk apparatus 100).

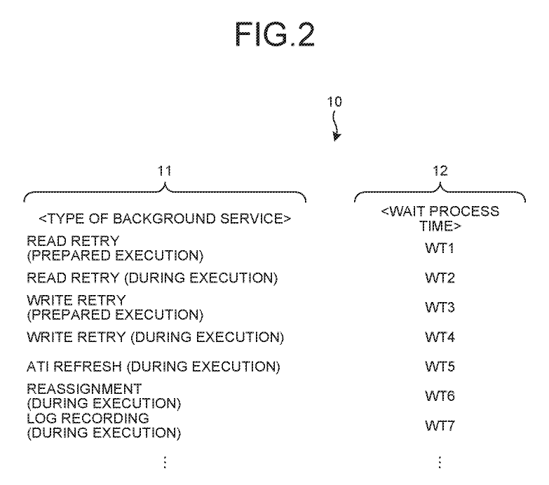

The controller 130 measures a vacancy securing time for each of the types of background services, and adds an operation margin time to the measured vacancy securing time to determine a period of time for performing a wait process (wait process time). Based on this determined content, the controller 130 creates a wait process time table 10, for example, as shown in FIG. 2, and stores it as management information about the disk apparatus 100 into the nonvolatile memory 128 or a management information storage area of the disk medium 111. FIG. 2 is a view showing a data structure of the wait process time table 10.

The wait process time table 10 includes information about a plurality of types of background services, which correlates each type of a background service to a wait process time. The wait process time table 10 includes a background service type column 11 and a wait process time column 12. In the background service type column 11, there are recorded the types of background services along with their execution situations (i.e., “prepared its execution” or “during its execution”) to be checked when the controller 130 executes a command from the host 140. In the wait process time column 12, there are recorded the periods of time for performing a wait process respectively for the types of background services.

The controller 130 can determine an appropriate wait process time according to the type of a background service by consulting the wait process time table 10 shown in FIG. 2. For example, in the case that the read retry is prepared its start, the wait process time is determined to be WT1 (for example, 60 ms). In the case that the read retry is during its execution, the wait process time is determined to be WT2 (for example, 30 ms). In the case that the write retry is prepared its start, the wait process time is determined to be WT3 (for example, 60 ms). In the case that the write retry is during its execution, the wait process time is determined to be WT4 (for example, 30 ms). In the case that the ATI refresh is during its execution, the wait process time is determined to be WT5 (for example, 100 ms). In the case that the data sector reassignment (reassignment) is during its execution, the wait process time is determined to be WT6 (for example, 50 ms). In the case that the log recording is during its execution, the wait process time is determined to be WT7 (for example, 50 ms). Here, although not shown, the wait process time table 10 may further include wait process times respectively for the case that the ATI refresh is prepared its start, for the case that the reassignment is prepared its start, and for the case that the reassignment is prepared its start.

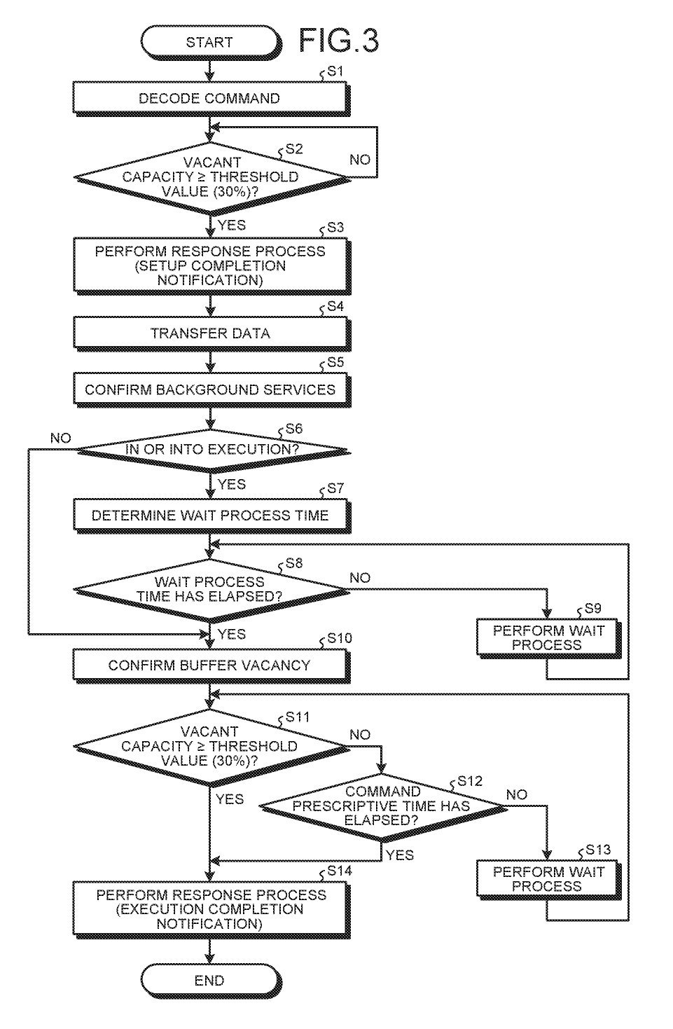

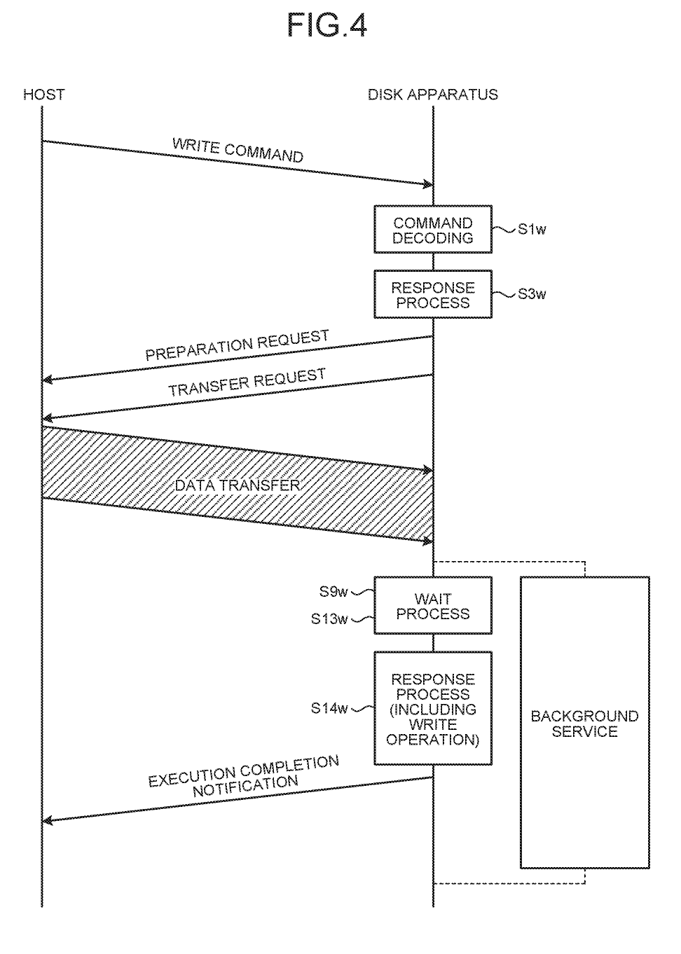

Next, an explanation will be give of an operation of the disk apparatus 100 with reference to FIGS. 3 and 4. FIG. 3 is a flow chart showing an operation of the disk apparatus 100. FIG. 4 is a sequence chart showing an operation of the disk apparatus 100 when it receives a write command.

In the disk apparatus 100, when receiving a command from the host 140, the controller 130 (host interface circuit 131h) decodes the command (S1 in FIG. 3). For example, the controller 130 decodes the received command and identifies it as a write command (S1w in FIG. 4).

In accordance with this result, the controller 130 (processor 126) waits until the vacant capacity of the buffer memory 129 becomes equal to or higher than a threshold value for its usable state (for example, 30% of the entire capacity) (No from S2 in FIG. 3). When the vacant capacity of the buffer memory 129 becomes equal to or higher than the threshold value for its usable state (Yes from S2), the controller 130 transmits a setup completion notification to the host 140, as a process of responding to the command (S3 in FIG. 3). For example, the controller 130 sequentially transmits to the host 140 a preparation request of requesting data preparation (for example, DMA Setup in SATA standard) and a transfer request of requesting data transfer (for example, DMA Active in SATA standard) as a setup completion notification (S3w in FIG. 4).

In response to the transmission of the setup completion notification from the disk apparatus 100 to the host 140, the data transfer is performed between the disk apparatus 100 and the host 140 (S4 in FIG. 3). For example, as shown in FIG. 4, upon reception of the transfer request, the host 140 transmits write data to the controller 130 of the disk apparatus 100.

In response to this, the controller 130 of the disk apparatus 100 confirms the execution schedule or execution state of each background service (S5 in FIG. 3), and makes a judgment as to whether a background service will be executed (S6). If there is no background service in a state prepared its execution or during its execution, the controller 130 judges that no background service will be executed (No from S6), and confirms the vacant capacity of the buffer memory 129 (S10).

If there is a background service in a state prepared its execution (the execution start is within a predetermined period of time from the current time) or during its execution, the controller 130 judges that a background service will be executed (Yes from S6), and confirms the type of the background service. The controller 130 determines a wait process time in accordance with the type of the background service (S7). The controller 130 can determine a wait process time corresponding to the type of the background service by consulting the wait process time table 10 (see FIG. 2).

The controller 130 performs a wait process (first wait process) (S9), until the wait process time determined in S7 has elapsed (No from S8). More specifically, the controller 130 starts a count operation by use of a timer (not shown) at the start timing of the wait process, and temporarily stops communication with the host 140, and the controller 130 observes the timer at intervals of 1 ms, for example, and repeats this timer observation until the time reaches the wait process time determined in S7 (S9w).

After the lapse of the wait process time (Yes from S8), i.e., when recognizing that the wait process time has elapsed by consulting the timer, the controller 130 confirms the vacant capacity of the buffer memory 129 (S10) If the vacant capacity of the buffer memory 129 is lower than the threshold value (No from S11), and a command prescriptive time has not yet elapsed (No from S12), the controller 130 keeps performing a wait process (second wait process) (S13, and S13w in FIG. 4). The command prescriptive time is an elapsed time from the command execution start, and is prescribed in advance as the upper limit of the command execution time in accordance with the specification of the host 140.

The controller 130 finishes the wait process when the vacant capacity of the buffer memory 129 becomes equal to or higher than the threshold value (Yes from S11 in FIG. 3), or when the command prescriptive time has elapsed (Yes from S12).

Thus, the controller 130 performs a process of responding to the command (S14). For example, the controller 130 performs a write operation of reading write data from the buffer memory 129 and writing it into the disk medium 111, and, upon completion of the write operation, the controller 130 transmits an execution completion notification about the write command (for example, SetDeviceBit in SATA standard) to the host 140 (S14w in FIG. 4). In this way, the response process (S14w) includes the write operation (access operation) and an operation of transmitting the execution completion notification about the write command to the host 140. Since the host 140 receives the execution completion notification about the write command, it can recognize that execution of the write command has been completed in the disk apparatus 100, and so can perform an image process and so forth by use of the write command response as a trigger.

As described above, in the disk apparatus 100, when the controller 130 executes a command that instructs an access operation to the disk medium 111, if a background service is in a state prepared its execution or during its execution, the controller 130 performs a wait process of delaying a process of responding to the command, which includes the access operation, by a time according to the background service. Consequently, the controller 130 can finish the wait process at the timing when the vacant capacity of the buffer memory 129 is expected to reach a threshold value for its usable state (for example, 30% of the entire capacity), and thereby it can reduce the unnecessary wait time for the access according to the command from the host 140. As a result, it becomes possible to prevent the occurrence of a long delay in responding to the host 140, and to prevent the prolongation of a response time with respect to the command from the host 140. Thus, under the circumstances that the host 140 is included in an information processing system serving as a game device for example, it is possible to reduce a period of time, in which the image processing operation in the information processing system (using a command response as a trigger) is temporarily stopped and the display device screen is frozen, so as to fall within a range of time negligible to the user (for example, not more than 500 ms). Consequently, the information processing system including the host 140 can avoid giving stress to the user.

Here, there is tentatively assumed a case that a wait process is performed until a background service is completed. In this case, an access operation according to a command from the host 140 may end up being unnecessarily kept on standby even after the vacant capacity of the buffer memory 129 reaches a threshold value for its usable state. Consequently, a response to the host 140 may be significantly delayed, thereby prolonging a response time with respect to the command from the host 140.

On the other hand, according to the embodiment, in the disk apparatus 100, if a background service is in a state prepared its execution or during its execution, the controller 130 performs a wait process for a time according to the background service. For example, the controller 130 determines a period of time (wait process time) for performing the wait process in accordance with the type of the background service, and performs the wait process for the wait process time thus determined. Consequently, since the wait process can be performed for an appropriate time according to the type of the background service, the unnecessarily wait time for the access according to a command from the host 140 can be reduced. As a result, it becomes possible to prevent the occurrence of a long delay in responding to the host 140, and to prevent the prolongation of a response time with respect to the command from the host 140.

It should be noted that the controller 130 may determine the wait process time in consideration of the history of the number of commands in addition to the type of a background service. For example, in relation to commands received from the host 140, the controller 130 counts the number of commands in past “t” seconds by use of a counter or the like (not shown), and holds the counted value. For example, the number of commands in past “t” seconds may be the number of commands received by the host interface circuit 131h from the host 140 in past “t” seconds. Alternatively, the controller 130 uses a counter or the like (not shown) to count the number of commands processed in past “t” seconds, and holds the counted value. For example, the number of commands in past “t” seconds may be the number of commands processed by the controller 130 in past “t” seconds. At S7 shown in FIG. 3, the controller 130 obtains a wait process time corresponding to the type of a background service by consulting the wait process time table 10 (see FIG. 2), and multiplies the obtained wait process time by a coefficient according to the number of commands in past “t” seconds, thereby determining a wait process time. This “t” is an arbitrary number larger than 0, and is 10, for example. In consideration of the fact that an increase in the number of commands entails a higher rate of filling the buffer memory 129, for which the use of a larger wait process time becomes more effective, it may be adopted to increase the coefficient from 1 along with an increase in the number of commands.

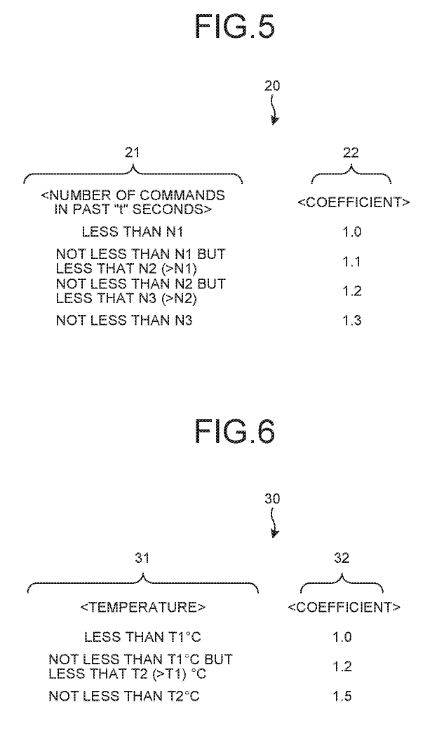

For example, prior to the processes of S1 to S14 shown in FIG. 3, the controller 130 measures a change in vacancy securing time according to the number of commands in past “t” seconds, and obtains a coefficient for multiplying the wait process time, based on the measurement result (for example, by calculating the ratio of a vacancy securing time for the number of commands in a period until the current time from “t” seconds before, relative to a vacancy securing time for the case that the number of commands for “t” seconds in the past is less than N1). Based on this obtained content, the controller 130 creates a coefficient table 20, for example, as shown in FIG. 5, and stores it as management information about the disk apparatus 100 into the nonvolatile memory 128 or a management information storage area of the disk medium 111. FIG. 5 is a view showing a data structure of the coefficient table 20.

The coefficient table 20 includes information that correlates the number of commands in past “t” seconds to the coefficient, in terms of a plurality of ranges of the number of commands. The coefficient table 20 includes a column 21 for the number of commands in past “t” seconds, and a coefficient column 22. In the column 21 for the number of commands in past “t” seconds, there are recorded ranges of the number of commands in past “t” seconds. In the coefficient column 22, there are recorded coefficients for multiplying the wait process time.

The controller 130 can obtain an appropriate coefficient according to the number of commands in past “t” seconds, as a coefficient for multiplying the wait process time, by consulting the coefficient table 20 shown in FIG. 5. For example, when the number of commands in past “t” seconds belongs to a range of “less than N1” (for example, N1=100), the coefficient is determined to be “1”. When the number of commands in past “t” seconds belongs to a range of “not less than N1 but less that N2” (for example, N2=500), the coefficient is determined to be “1.1”. When the number of commands in past “t” seconds belongs to a range of “not less than N2 but less that N3” (for example, N3=1,000), the coefficient is determined to be “1.2”. When the number of commands in past “t” seconds belongs to a range of “not less than N3”, the coefficient is determined to be “1.3”.

Alternatively, the controller 130 may determine the wait process time in consideration of the ambient temperature around the disk medium 111 in addition to the type of a background service. For example, in relation to the ambient temperature around the disk medium 111, the controller 130 obtains a temperature detected by the temperature sensor 141 and holds it. At S7 shown in FIG. 3, the controller 130 obtains a wait process time corresponding to the type of a background service by consulting the wait process time table 10 (see FIG. 2), and multiplies the obtained wait process time by a coefficient according to the ambient temperature around the disk medium 111, thereby determining a wait process time. In consideration of the fact that an increase in the temperature entails an increase in the electric resistance of the coil of a motor for operating the head 122, which hinders the flow of electric current, i.e., this weakens the power of the motor and slows the entire operation of the disk apparatus 100 including a background service, it may be adopted to increase the coefficient from 1 along with an increase in the temperature.

For example, prior to the processes of S1 to S14 shown in FIG. 3, the controller 130 measures a change in vacancy securing time according to the temperature, and obtains a coefficient for multiplying the wait process time, based on the measurement result (for example, by calculating the ratio of a vacancy securing time at the current temperature, relative to a vacancy securing time at a temperature of less than T1° C.). Based on this obtained content, the controller 130 creates a coefficient table 30, for example, as shown in FIG. 6, and stores it as management information about the disk apparatus 100 into the nonvolatile memory 128 or a management information storage area of the disk medium 111. FIG. 6 is a view showing a data structure of the coefficient table 30.

The coefficient table 30 includes information that correlates the temperature to the coefficient, in terms of a plurality of ranges of the temperature. The coefficient table 30 includes a temperature column 31 and a coefficient column 32. In the temperature column 31, there are recorded ranges of the temperature. In the coefficient column 32, there are recorded coefficients for multiplying the wait process time.

The controller 130 can obtain an appropriate coefficient according to the temperature, as a coefficient for multiplying the wait process time, by consulting the coefficient table 30 shown in FIG. 6. For example, when the temperature belongs to a range of “less than T1° C.” (for example, T1=50), the coefficient is determined to be “1”. When the temperature belongs to a range of “not less than TIC but less that T2° C.” (for example, T2=60), the coefficient is determined to be “1.2”. When the temperature belongs to a range of “not less than T2° C.”, the coefficient is determined to be “1.5”.

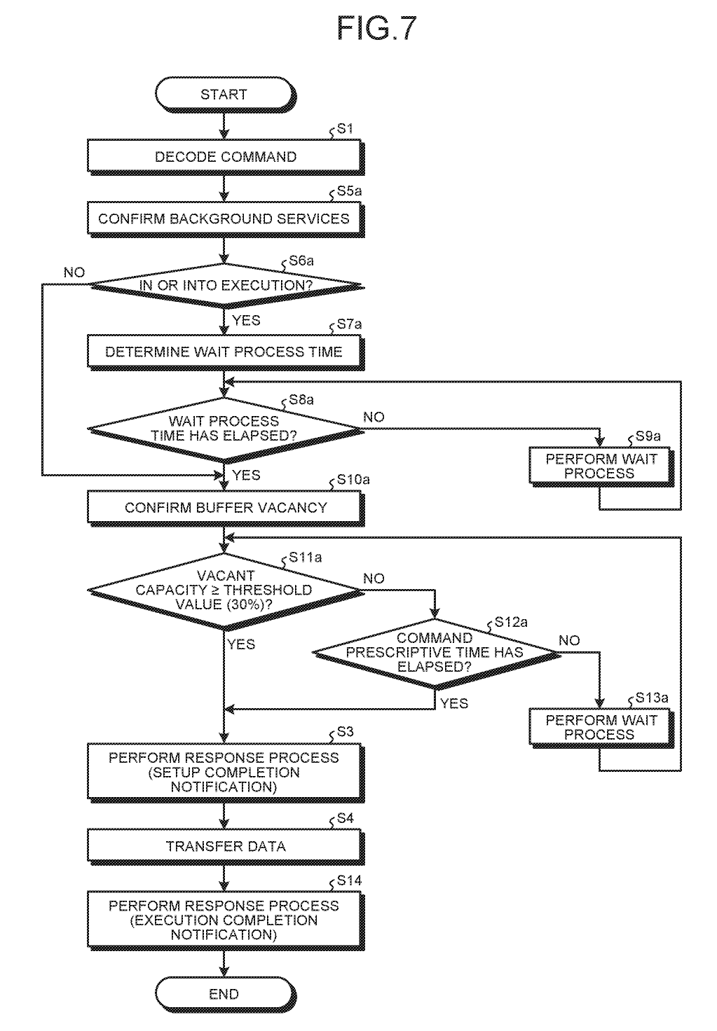

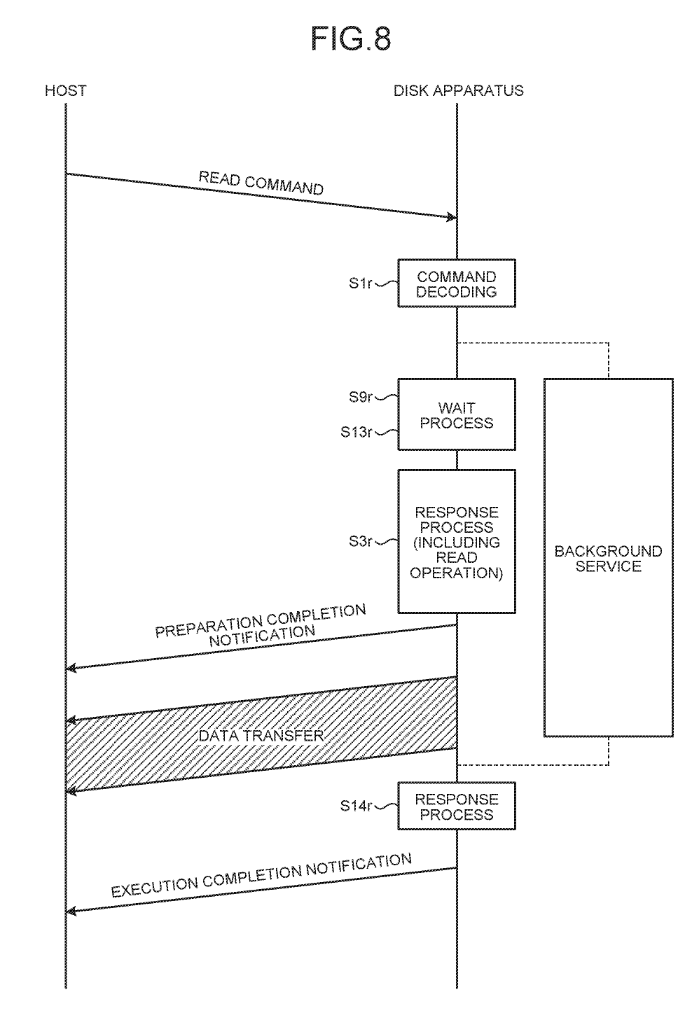

Further, in an operation of the disk apparatus 100, a wait process may be performed before a response process including an operation of transmitting a setup completion notification. For example, as shown in FIG. 7, the controller 130 may performs operations described in S5a to S13a before an operation (S3) of transmitting a setup completion notification to the host 140. FIG. 7 is a flow chart showing another operation of the disk apparatus 100. The operation contents of S5a to S13a are the same as the operation contents of S5 to S13 shown in FIG. 3. FIG. 8 is a sequence chart showing an operation of the disk apparatus 100, when receiving a read command.

For example, the controller 130 decodes the received command and identifies it as a read command (S1r in FIG. 8).

In accordance with this result, the controller 130 of the disk apparatus 100 confirms the execution schedule or execution state of each background service (S5a in FIG. 7), and makes a judgment as to whether a background service will be executed (S6a). If there is no background service in a state prepared its execution or during its execution, the controller 130 judges that no background service will be executed (No from S6a), and confirms the vacant capacity of the buffer memory 129 (S10a).

If there is a background service in a state prepared its execution (the execution start is within a predetermined period of time from the current time) or during its execution, the controller 130 judges that a background service will be executed (Yes from S6a), and confirms the type of the background service. The controller 130 determines a wait process time in accordance with the type of the background service (S7a).

The controller 130 performs a wait process (first wait process) (S9a), until the wait process time determined in S7a has elapsed (No from S8a). More specifically, the controller 130 starts a count operation by use of a timer (not shown) at the start timing of the wait process, and sets on standby an operation of reading data from the disk medium 111 in accordance with the read command received by the host interface circuit 131h (S9r in FIG. 8).

After the lapse of the wait process time (Yes from S8a in FIG. 7), i.e., when recognizing that the wait process time has elapsed by consulting the timer, the controller 130 confirms the vacant capacity of the buffer memory 129 (S10a). If the vacant capacity of the buffer memory 129 is lower than a threshold value (No from S11a), and a command prescriptive time has not yet elapsed (No from S12a), the controller 130 keeps performing a wait process (second wait process) (S13a, and S13r in FIG. 8). The command prescriptive time is an elapsed time from the command execution start, and is prescribed in advance as the upper limit of the command execution time in accordance with the specification of the host 140.

The controller 130 finishes the wait process when the vacant capacity of the buffer memory 129 becomes equal to or higher than the threshold value (Yes from S11a in FIG. 7), or when the command prescriptive time has elapsed (Yes from S12a).

Thus, the controller 130 performs a process of responding to the command (S3). Specifically, the controller 130 performs a read operation and stores the read data read from the disk medium 111 into the buffer memory 129. Upon completion of the read operation, the controller 130 transmits a preparation completion notification (for example, DMA Setup in SATA standard) of notifying completion of data preparation, as a setup completion notification, to the host 140 (S3r in FIG. 8). In this way, the response process (S3r in FIG. 8) includes the read operation (access operation) and an operation of transmitting the preparation completion notification.

In accordance with the transmission of the setup completion notification from the disk apparatus 100 to the host 140, data transfer is performed between the disk apparatus 100 and the host 140 (S4 in FIG. 7). For example, after transmitting the preparation completion notification, the disk apparatus 100 (controller 130) transmits the read data to the host 140, and thereby data transfer is performed from the disk apparatus 100 to host 140.

Further, the controller 130 performs a process of responding to the command (S14 in FIG. 7). For example, upon completion of transmitting the read data to the host 140, the controller 130 transmits an execution completion notification about the read command (for example, SetDeviceBit in SATA standard) to the host 140 (S14r in FIG. 8). Since the host 140 receives the execution completion notification about the read command, it can recognize that execution of the read command has been completed in the disk apparatus 100, and so can perform an image process and so forth by use of the read command response as a trigger.

In this way, also in the case that a wait process is performed before a response process including an operation of transmitting the setup completion notification, the wait process can be finished at the timing when the vacant capacity of the buffer memory 129 is expected to reach a threshold value for its usable state (for example, 30% of the entire capacity), and thereby the unnecessary wait time for the access according to a command from the host 140 can be reduced. As a result, it becomes possible to prevent the occurrence of a long delay in responding to the host 140, and to prevent the prolongation of a response time with respect to the command from the host 140. Thus, under the circumstances that the host 140 is included in an information processing system serving as a game device for example, it is possible to reduce a period of time, in which the image processing operation in the information processing system (using a command response as a trigger) is temporarily stopped and the display device screen is frozen, so as to fall within a range of time negligible to the user (for example, not more than 500 ms). Consequently, the information processing system including the host 140 can avoid giving stress to the user.

It should be noted that the concept of the embodiment described above is applicable not only to the disk apparatus 100 but also to a memory system including a plurality of nonvolatile memories, such as an SSD (Solid State Drive). Specifically, the explanation described above can be applied to a memory system by replacing “disk apparatus 100” with “memory system” and replacing “disk medium 111” with “a plurality of nonvolatile memories”. Each of the plurality of nonvolatile memories is formed of a NAND type flash memory, for example. The NAND type flash memory includes a memory cell array composed of a plurality of memory cells arranged in a matrix format, in which each memory cell may be configured to perform multi-value storage by use of a higher order page and a lower order page, for example. In the NAND type flash memory, data erasure is performed in units of a block, and data writing and data reading are performed in units of a page. Each block is composed of a plurality of pages.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk apparatus comprising:
a disk medium;
a buffer memory; and
a controller including an interface circuit used to connect to the buffer memory, in an execution of a command from a host to instruct a first access operation to the disk medium by using the buffer memory, and configured to perform, if a second access operation to the disk medium by using the buffer memory is performed in background, a first wait process by a time according to the second access operation, the first wait process delaying a response process of the command, the response process including the first access operation.

2. The disk apparatus according to claim 1, wherein
the controller further performs a second wait process delaying the response process, if a vacant capacity of the buffer memory is lower than a threshold value.

3. The disk apparatus according to claim 2, wherein
the controller finishes the second wait process, if a vacant capacity of the buffer memory is higher than or equal to the threshold value, or, if a time prescribed in advance has elapsed from an execution start of the command.

4. The disk apparatus according to claim 1, wherein
the controller determines the time in accordance with a type of the second access operation, and performs the first wait process by the determined time.

5. The disk apparatus according to claim 1, wherein
the controller determines the time in accordance with a type of the second access operation and a history of a number of commands, and performs the first wait process by the determined time.

6. The disk apparatus according to claim 1, wherein
the controller determines the time in accordance with a type of the second access operation and an ambient temperature around the disk medium, and performs the first wait process by the determined time.

7. The disk apparatus according to claim 1, wherein
the controller further includes a host interface, and
wherein the response process includes
the first access operation, and
an operation of transmitting an execution completion notification of the command to the host via the host interface.

8. The disk apparatus according to claim 1, wherein
the controller includes a host interface, and
wherein the response process includes
the first access operation, and
an operation of transmitting a setup completion notification of the command to the host via the host interface.

9. A storage apparatus comprising:
a storage medium;
a buffer memory; and
a controller including an interface circuit used to connect to the buffer memory, and a processor configured to perform, in an execution of a command from a host to instruct a first access operation to the storage medium by using the buffer memory, if a second access operation to the storage medium by using the buffer memory is performed in background, a first wait process by a time according to the second access operation, the first wait process delaying a response process of the command, the response process including the first access operation.

10. The storage apparatus according to claim 9, wherein
the processor further performs a second wait process delaying the response process, if a vacant capacity of the buffer memory is lower than a threshold value.

11. The storage apparatus according to claim 10, wherein
the processor finishes the second wait process, if a vacant capacity of the buffer memory is higher than or equal to the threshold value, or, if a time prescribed in advance has elapsed from an execution start of the command.

12. The storage apparatus according to claim 9, wherein
the processor determines the time in accordance with a type of the second access operation, and performs the first wait process by the determined time.

13. The storage apparatus according to claim 9, wherein
the processor determines the time in accordance with a type of the second access operation and a history of a number of commands, and performs the first wait process by the determined time.

14. The storage apparatus according to claim 9, wherein
the processor determines the time in accordance with a type of the second access operation and an ambient temperature around the storage medium, and performs the first wait process by the determined time.

15. A control method of a disk apparatus including a disk medium and a buffer memory,
the method comprising executing a command from a host to instruct a first access operation to the disk medium by using the buffer memory, wherein
the execution of the command including performing, if a second access operation to the disk medium by using the buffer memory is performed in background, a first wait process by a time according to the second access operation, the first wait process delaying a response process of the command, the response process including the first access operation.

16. The control method according to claim 15, wherein
the execution of the command includes performing a second wait process delaying the response process after performing the first wait process, if a vacant capacity of the buffer memory is lower than a threshold value.

17. The control method according to claim 16, wherein
the execution of the command includes finishing the second wait process, if a vacant capacity of the buffer memory is higher than or equal to the threshold value, or, if a time prescribed in advance has elapsed from an execution start of the command.

18. The control method according to claim 15, wherein
the performing the first wait process includes
determining the time in accordance with a type of the second access operation, and
performing the first wait process by the determined time.

19. The control method according to claim 15, wherein
the performing the first wait process includes
determining the time in accordance with a type of the second access operation and a history of a number of commands, and
performing the first wait process by the determined time.

20. The control method according to claim 15, wherein
the performing the first wait process includes
determining the time in accordance with a type of the second access operation and an ambient temperature around the disk medium, and
performing the first wait process by the determined time.
